(19) United States
(12) Patent Application Publication
(10) Pub. No.: US 2025/0117997 A1
(43) Pub. Date: Apr. 10, 2025

(54) VIRTUAL WHITEBOARD SYSTEM AND METHOD

(71) Applicant: LENOVO (SINGAPORE) PTE. LTD., SINGAPORE (SG)

(72) Inventors: Rafael Marius Radkowski, Cary, NC (US); Angela Vivian Dcosta, Bangalore (IN); Chunbo Song, Arlington, VA (US)

(21) Appl. No.: 18/483,379

(22) Filed: Oct. 9, 2023

(51) Int. Cl. G06T 11/60; G06T 3/40; G06T 5/00; G06T 5/20; G06V 20/50; G06V 20/62; G06V 30/19; G06V 30/22

(52) U.S. Cl. CPC G06T 11/60; G06T 3/40; G06T 5/20; G06T 5/73; G06V 20/50; G06V 20/63; G06V 30/19; G06V 30/22

(57) ABSTRACT

A virtual whiteboard system includes a memory and one or more processors. The processor(s) analyze image data generated by a camera, and detect a drawing board in the image data. The processor(s) analyze a portion of the image data that is within the drawing board to detect user-based content that is selectively displayed on a surface of the drawing board by a user. The processor(s) determine a command associated with the user-based content that is on the surface of the drawing board, and implement the command to generate a virtual whiteboard image.

### FIELD

The present disclosure generally relates to virtual representations of drawing boards, such as virtual representations of drawing boards communicated during video conference meetings.

### BACKGROUND OF THE INVENTION

Some video conferencing systems utilize a camera to capture video of a room that includes a drawing board. A user that is presenting during a video conference meeting may be present in the room and may use the drawing board to present content to remote participants of the video conference meeting. The presenter may draw text and/or graphics on the drawing board. The video conferencing systems may display the text and/or graphics drawn by the presenter in a virtual whiteboard that is communicated to the remote participants and displayed on computer devices of the remote participants.

The known virtual whiteboards have several limitations and drawbacks. For example, known virtual whiteboards have limited interactivity and control by the user (e.g., presenter) at the drawing board. For example, some known virtual whiteboards do not have editing tools that allow the user to modify the content that is captured on the drawing board by the camera such that the virtual whiteboard displays modified content rather than simply a rendered version of the image data. Editing tools may include cropping, magnifying, highlighting, augmenting the captured content with additional content, and the like. The systems that do provide tools have limitations, such as requiring the user to set up the tools prior to the meeting, requiring the user to hold a fiducial marker while presenting and/or make pre-defined gestures within the field of view of the camera, and the like. Furthermore, the rendered content displayed on the known virtual whiteboards may be relatively fuzzy/unsharp. As such, it may be difficult for a remote participant to decipher and understand the content that the presenter is applying to the drawing board. A need remains for enhancing the interactivity and clarity of content presented on a virtual whiteboard.

### SUMMARY

In accordance with an example or aspect, a virtual whiteboard system is provided that includes a memory configured to store program instructions, and one or more processors operably connected to the memory. The program instructions are executable by the one or more processors to analyze image data generated by a camera, and detect a drawing board in the image data. The one or more processors are configured to analyze a portion of the image data that is within the drawing board to detect user-based content that is selectively displayed on a surface of the drawing board by a user. The one or more processors are configured to determine a command associated with the user-based content that is on the surface of the drawing board, and implement the command to generate a virtual whiteboard image.

Optionally, the one or more processors are configured to communicate the virtual whiteboard image to one or more remote computer devices to allow one or more remote participants of a video conference meeting to view the virtual whiteboard image.

Optionally, the one or more processors are configured to analyze the portion of the image data within the drawing board to detect at least one of (i) a token that is manually affixed to the surface of the drawing board by the user or (ii) content that is handwritten by the user on the surface of the drawing board using a writing instrument. The one or more processors may analyze the portion of the image data within the drawing board to detect a graphical symbol that represents the user-based content. Optionally, the one or more processors may analyze the portion of the image data within the drawing board to detect the user-based content by performing optical character recognition on the portion of the image data within the drawing board. The one or more processors may identify a first character drawn by the user on the surface of the drawing board based on the optical character recognition, and select a first set of sharpening parameters based on an identity of the first character. The one or more processors may then apply a sharpening high pass filter having the first set of sharpening parameters to a portion of the image data that depicts the first character, and render an output of the sharpening high pass filter to present the first character on the virtual whiteboard image. Optionally, the one or more processors are configured to record text representing the user-based content on the drawing board that is detected via the optical character recognition over time, and generate an exportable document that includes a transcript of the text that is recorded during a video conference meeting.

Optionally, the one or more processors are configured to analyze the portion of the image data within the drawing board to detect the user-based content by performing optical pattern matching on the portion of the image data within the drawing board. The one or more processors may determine the command associated with the user-based content by accessing a look-up table that provides a list of different types of user-based content and corresponding commands associated with the different types. In response to determining that the command is to perform a zoom-in function, the one or more processors may implement the command by magnifying content that is displayed in the virtual whiteboard image. The one or more processors may be configured to analyze second image data generated by the camera after the content displayed on the virtual whiteboard image is magnified. In response to detecting that the user-based content associated with the zoom-in function is no longer displayed on the surface of the drawing board, the one or more processors may be configured to implement a zoom-out function to generate a second virtual whiteboard image.

Optionally, the one or more processors are configured to implement the command by one or more of changing a zoom level of a virtual whiteboard display interface, highlighting text on the virtual whiteboard display interface, adding a mention to a remote user that can view the virtual whiteboard display interface, adding an emoji on the virtual whiteboard display interface, or displaying a designated file on the virtual whiteboard display interface. Optionally, the one or more processors are configured to analyze the portion of the image data that is within the drawing board to detect the user-based content by analyzing all of the image data that is within an outer boundary of the drawing board. Optionally, the one or more processors are configured to apply a first algorithm to the image data that depicts the drawing board to detect edges of the drawing board. The one or more processors may then determine a plane normal vector of the drawing board, and apply a motion stability filter based on the plane normal vector to correct for motion of the camera by removing high frequency components from the image data within the outer boundary of the drawing board.

In accordance with an example or aspect, a method of enhancing a virtual whiteboard is provided. The method includes analyzing image data generated by a camera, and detecting a drawing board in the image data. The method includes analyzing a portion of the image data that is within the drawing board to detect user-based content that is selectively displayed on a surface of the drawing board by a user. The method includes determining a command associated with the user-based content that is on the surface of the drawing board, and implementing the command to generate a virtual whiteboard image.

Optionally, the method includes communicating the virtual whiteboard image to one or more remote computer devices to allow one or more remote participants of a video conference meeting to view the virtual whiteboard image. Optionally, analyzing the portion of the image data within the drawing board may be performed to detect at least one of (i) content that is handwritten by the user on the surface of the drawing board using a writing instrument or (ii) a token that is manually affixed to the surface of the drawing board by the user. Implementing the command to generate the virtual whiteboard image may include editing content and/or augmenting content displayed on a virtual whiteboard display interface.

Optionally, the method may include performing optical character recognition on the portion of the image data within the drawing board to detect the user-based content, and identifying a first character drawn by the user on the surface of the drawing board based on the optical character recognition. The method may include selecting a first set of sharpening parameters based on an identity of the first character, and applying a sharpening high pass filter having the first set of sharpening parameters to a portion of the image data that depicts the first character. The method may include rendering an output of the sharpening high pass filter to present the first character on the virtual whiteboard image.

In accordance with an example or aspect, a computer program product is provided that includes a non-transitory computer readable storage medium. The non-transitory computer readable storage medium includes computer executable code configured to be executed by one or more processors to analyze image data generated by a camera, and detect a drawing board in the image data. The one or more processors may execute the computer executable code to analyze a portion of the image data that is within the drawing board to detect user-based content that is selectively displayed on a surface of the drawing board by a user, and determine a command associated with the user-based content that is on the surface of the drawing board. The one or more processors may execute the computer executable code to implement the command to generate a virtual whiteboard image.

### BRIEF DESCRIPTION OF THE DRAWINGS

FIG. 1 is a block diagram of a virtual whiteboard system according to an embodiment.

FIG. 2 is a diagram of a communication system according to an embodiment.

FIG. 3 is a functional diagram describing various operations of the virtual whiteboard system according to an embodiment.

FIG. 4 is an image that depicts a drawing board mounted on a wall of a room.

FIG. 5 is an image showing a user presenting at the drawing board.

FIG. 6 illustrates a virtual whiteboard image that may be generated by the virtual whiteboard system according to an embodiment.

FIG. 7 is an image showing the user presenting at the drawing board.

FIG. 8 is a diagram that shows an input image, an OCR output, and a virtual whiteboard image to explain a sharpening function according to an embodiment.

FIG. 9 is an image depicting the drawing board in a room.

FIG. 10 is a flow chart of a method of enhancing a virtual whiteboard according to an embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Embodiments described herein disclose a virtual whiteboard system and method that increases the interactivity of user editing tools and improves the clarity and/or readability of handwritten content relative to known video conferencing systems that provide virtual whiteboards. In an embodiment, the system and method described herein increase interactivity by enabling a user at the drawing board to submit commands by selectively manually displaying content on a surface of the drawing board. For example, the user may draw a first graphical symbol on the surface of the drawing board. The first graphical symbol is associated with a first command. The system and method may analyze image data depicting the drawing board to detect the first graphical symbol displayed on the surface. Upon identifying the first graphical symbol, the system and method may determine the first command based on a predetermined relationship between the first graphical symbol and the first command. The system and method may implement the first command to generate a virtual whiteboard image. The virtual whiteboard image may be part of a video feed that is communicated to one or more remote participants of a video conference meeting. In an example, the first command may be a zoom-in editing command, and the virtual whiteboard image may be generated that magnifies content displayed in the virtual whiteboard image (relative to the scale of content displayed in a prior virtual whiteboard image). The system and method are able to detect and interpret various different types of user-based content applied to the drawing board by the user to function as commands.

In an example use application, the system and method may be used during video conference meetings (e.g., calls), although the virtual whiteboard system and method disclosed herein are not limited to video conferencing applications. For example, the virtual whiteboard image generated by implementing a command based on user content applied to the drawing board can be recorded in a memory device, communicated to a remote computer device outside of a video conference meeting (such as in an email), and/or the like.

The term “drawing board” as used herein can refer to any board that can be interacted with by a user to display content drawn by the user. Typically, a drawing board is mounted on a wall in a room. Some boards may cover a majority or an entirety of a wall in a room. The room may be a conference room, an office, a classroom, or the like. Example drawing boards can include chalkboards, dry erase-style whiteboards, “smart” whiteboards, computer devices with wall-mounted interactive displays, and the like. A user may interact with the drawing board by applying handwritten text and/or graphics using a writing instrument. The writing instrument may make physical marks on the surface of the drawing board or may virtually mark the drawing board using electronic tracking technology. For example, the writing instrument may be a pen, marker, chalk, electronic stylus, or the like.

The term “virtual whiteboard” refers to a computer-based simulation of a presentation board (e.g., a dry erase-style whiteboard). The virtual whiteboard may be generated by modifying image data received that depicts a physical drawing board in a room. The virtual whiteboard may present an altered version of the content that is actually displayed on the drawing board, as captured in image data by a camera. The image data may be modified by a computer by rectifying the image data (e.g., to modify an orientation of the drawing board and/or the content thereon), augmenting and/or enhancing the depicted content on the drawing board, rendering the image data for display on a display device, and/or the like. The virtual whiteboard may present the content in a way in which it appears that the observer is in the room and positioned directly in front of the surface of the drawing board. The term “virtual whiteboard image” as used herein is an image that may form part of the virtual whiteboard. For example, each virtual whiteboard image may be part of a video feed that is communicated to one or more remote computer devices for viewing by one or more remote users. The virtual whiteboard images may be rendered and displayed on the remote computer devices using a program referred to herein as a virtual whiteboard display interface. The virtual whiteboard display interface may be a graphical user interface that controls how the virtual whiteboard images are displayed on the remote computer devices. The word “whiteboard” in these terms is not meant to limit the type of the digital simulated board that is presented to being a dry erase whiteboard. For example, the virtual whiteboard image may be generated in which user-based content is displayed on a digital background that resembles a chalkboard, a painting canvas, a smartboard, or essentially any type of background image.

The term “token” as used herein can refer to discrete objects that can be held by a user and selectively affixed and removed from a surface of a drawing board. Example tokens can include magnets, stickers, sticky notes, note papers, decals, and the like. “Graphical symbols” as used herein can refer to characters (e.g., letters, numbers, text, etc.), pictorial representations (e.g., printed images, shapes, etc.), and freeform user illustrations (e.g., hand-drawn elements). References herein to “computer device”, unless specified, shall mean any of various types of hardware devices that perform processing operations, such as servers, computer workstations, personal computers (e.g., laptop, desktop, tablet, smart phone, wearable computer, etc.), standalone video conference hub devices or stations, and the like.

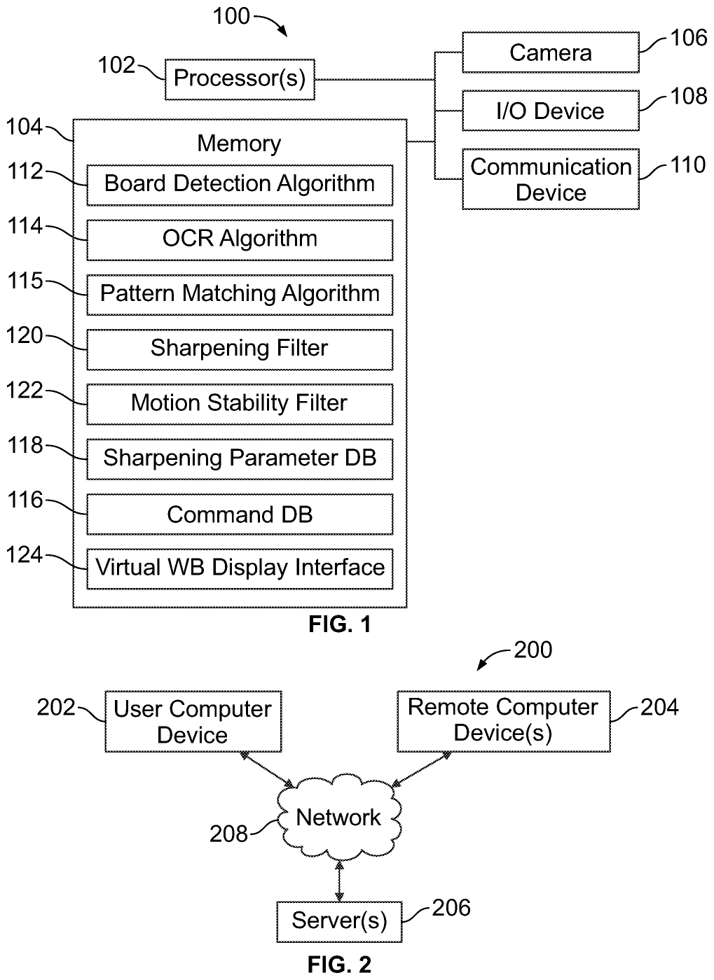

FIG. 1 is a block diagram of a virtual whiteboard system 100 according to an embodiment. The virtual whiteboard system 100 obtains image data that depicts a drawing board, analyzes the image data, and generates a virtual whiteboard image. The virtual whiteboard system 100 performs additional functions as described herein. The virtual whiteboard system 100 includes one or more processors 102 that perform some or all of the operations of the virtual whiteboard system 100 described herein. The virtual whiteboard system 100 also includes one or more tangible and non-transitory computer-readable storage media (e.g., data storage devices), referred to herein as memory 104. The memory 104 may store programmed instructions (e.g., software) that are executed by the one or more processors 102 to perform the operations described herein. For example, the program instructions stored in the memory 104 may be executable by the one or more processors 102 to analyze image data generated by a camera and detect a drawing board in the image data. The program instructions may be executable by the one or more processors 102 to analyze a portion of the image data that is within the drawing board to detect user-based content that is selectively displayed on a surface of the drawing board by a user. The program instructions may also be executable by the one or more processors 102 to determine a command associated with the user-based content that is on the surface of the drawing board and implement the command to generate a virtual whiteboard image.

The one or more processors 102 represent hardware circuitry, such as one or more microprocessors, integrated circuits, microcontrollers, field programmable gate arrays, etc.). The one or more processors 102 may be only a single processor. In a second example, the one or more processors 102 may be multiple processors integrated within a single controller device. In a third example, the one or more processors 102 may be multiple processors that are integrated into different, discrete computer devices (e.g., personal computers, servers, cloud storage and/or computing devices, etc.), where the processors 102 are communicatively connected to perform the operations of the virtual whiteboard system 100 described herein. For example, a first subset of the processors 102 may perform a first function of the virtual whiteboard system 100, and a second subset of the processors 102 may perform a second function of the virtual whiteboard system 100 based on communication with the first subset. For ease of description, the one or more processors 102 are referred to herein in the singular as “processor” 102, although it is understood that the term may represent multiple processors in some embodiments.

The virtual whiteboard system 100 optionally may include additional components. The additional components are operably connected to the processor 102 via wired and/or wireless communication links to permit the transmission of information in the form of signals. For example, the processor 102 may generate control signals that are transmitted to the other components to control operation of the components. The additional components may include a camera 106, an input-output device 108 (referred to herein as I/O device), and a communication device 110. virtual whiteboard system 100 may have additional components that are not shown in FIG. 1. In an alternative embodiment, the virtual whiteboard system 100 may lack one or more of the components that are shown in FIG. 1.

The camera 106 is an optical sensor that generates (e.g., captures) image data representative of subject matter within a field of view of the camera 106 at the time that the image data is generated. The image data may be a series of image frames generated over time. The series of image frames may be a video. In an embodiment, the camera 106 may be generally fixed in place during use, such as mounted to a user computer device which is stationary on a desk while the user computer device is operated. For example, the camera 106 may be a webcam that is oriented to face toward a drawing board in a room. The field of view may encompass the drawing board and also a user that is present in front of or next to the drawing board. With the camera 106 orientation set, the environment that is captured in the image data may remain relatively constant except for movements within the environment and/or vibrations or other movements that shake or move the camera 106. The image data generated by the camera 106 may be received and analyzed by the processor 102 to generate the virtual whiteboard image as described herein. For example, the processor 102 may receive the image data as one or more input images, and may process the input image(s) to generate output image(s) in the form of a virtual whiteboard that may be communicated to one or more remote computer devices.

The communication device 110 represents hardware circuitry that can communicate electrical signals via wireless communication pathways and/or wired conductive pathways. The processor 102 may control the communication device 110 to remotely communicate audio and video. For example, during a video conference meeting, the communication device 110 may be used to communicate a video feed that includes one or more virtual whiteboard images through a network to remote computer devices controlled by other participants of the video conference meeting. The communication device 110 may include hardware circuitry for establishing a network connection to remote computer devices. The hardware circuitry may include a router, a modem, a transceiver, and/or the like. Optionally, the communication device 110 may include transceiving circuitry, one or more antennas, and/or the like for wireless communication.

The I/O device 108 includes one or more input components designed to receive user inputs (e.g., selections) from a user that interacts with the virtual whiteboard system 100. The input components of the I/O device 108 may include or represent a touch sensitive screen or pad, a mouse, a keyboard, a joystick, a switch, physical buttons, and/or the like. The I/O device 108 may be integrated into a user computer device 202 (shown in FIG. 2) of the user. The user may actuate the I/O device 108 to open a video conferencing program or application and to initiate a video conference meeting. The operations of the virtual whiteboard system 100 described herein optionally may be performed within the video conferencing program and during the video conference meeting. The user may also use the input components to adjust or select settings of the virtual whiteboard system 100, such as to define or modify relationships between user-based content displayed on the drawing board and associated commands. The one or more output components of the I/O device 108 may include a display screen that presents graphical indicia, such as text and symbols, for viewing by the user. The display screen may display a graphical user interface (GUI) of an application or website, such as a video conferencing platform's application or website.

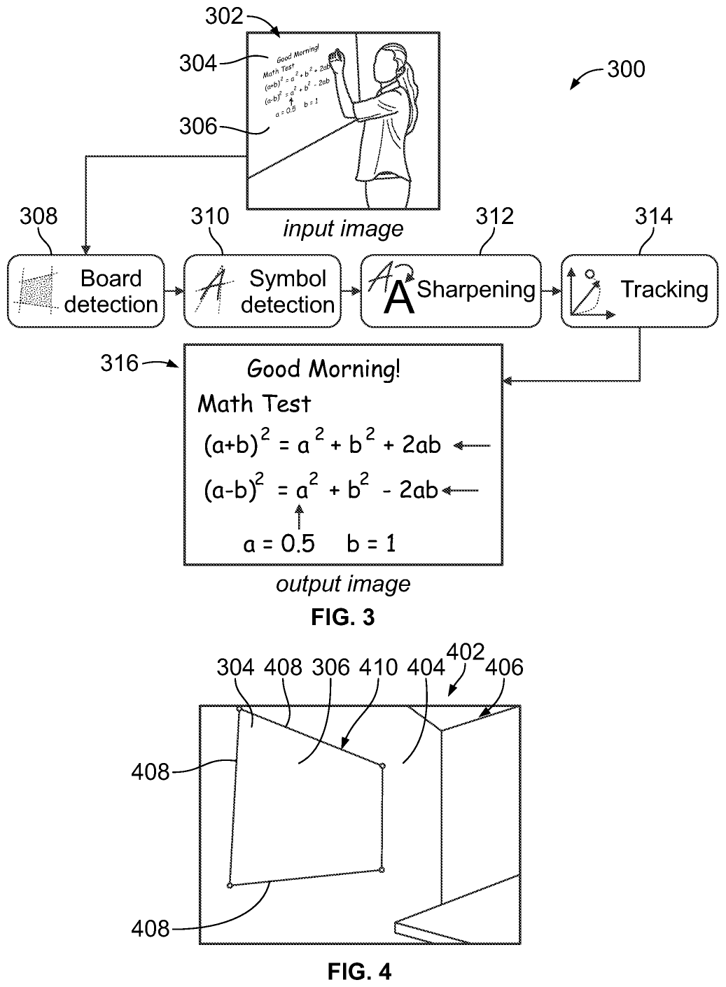

The programmed instructions stored in the memory 104 may include one or more algorithms, databases, programs (e.g., applications, files, etc.), filters, and/or the like that are utilized by the processor 102 to perform the operations of the virtual whiteboard system 100. These aspects are described in detail with reference to FIGS. 3 through 9. The memory 104 may store additional applications, such as various application program interfaces (APIs) that link to cloud hosting services, via the communication device 110, for accessing information from servers and other remote data storage devices.

FIG. 2 is a diagram of a communication system 200 according to an embodiment. The communication system 200 includes a user computer device 202, one or more remote computer devices 204, and one or more servers 206. The remote computer devices 204 and the servers 206 may be external and remote from the user computer device 202. For example, the servers 206 may be located at a data center. The user computer device 202 may be communicatively connected to the remote computer devices 204 and the servers 206 via a network 208. The network 208 may be the Internet, a local area network (LAN), a cellular network, or the like. The servers 206 may provide various cloud-based services to the user computer device 202 and/or the remote computer devices 204 via the network 208. The services may include data storage and/or cloud computing.

The user computer device 202 represents a computer device that performs at least some of the operations of the virtual whiteboard system 100. In an embodiment, at least most of the components of the virtual whiteboard system 100 shown in FIG. 1 are disposed on or within the user computer device 202. For example, at least some of the one or more processors 102, the one or more memories 104, the camera 106, the I/O device 108, and the communication device 110 may be commonly held within and/or on a housing or case of the user computer device 202. The user computer device 202 may be a computer or video conferencing hub device within a room that has the drawing board that is imaged as the basis for the virtual whiteboard image. The remote computer devices 204 may receive output image data that is generated by the virtual whiteboard system 100. The output image data includes one or more virtual whiteboard images that are generated by the processor 102. The output image data may be a video feed.

The virtual whiteboard system 100 may be used in conjunction with a video conferencing platform. For example, the operations of the virtual whiteboard system 100 may be incorporated into the program instructions of a video conferencing application that is downloaded onto the user computer device 202. In an example, the user computer device 202 and the remote computer devices 204 may collectively participate in a video conference meeting in which a user at the drawing board presents. During the meeting, the user computer device 202 may transmit the output image data, including the virtual whiteboard image(s) that are generated, to the remote computer devices 204 and/or the servers 206 via the network 208. The user computer device 202 may receive audio and/or video streams generated by the remote computer devices 204 as well.

Optionally, in an embodiment of the virtual whiteboard system 100 that includes multiple processors 102, the processors 102 may be distributed between the user computer device 202 and the one or more servers 206. In an alternative embodiment, the one or more processors 102 of the virtual whiteboard system 100 may be disposed only on the user computer device 202.

FIG. 3 is a functional diagram 300 describing various operations of the virtual whiteboard system 100 according to one or more embodiments. The operations may be performed by the processor 102 (shown in FIG. 1) by executing program instructions stored in the memory 104 (FIG. 1). The processor 102 receives image data as an input. The image data may include a first image 302 (e.g., an input image). The input image 302 may be an image frame from a video. The input image 302 may be generated by the camera 106 (shown in FIG. 1). The input image 302 depicts a drawing board 304. The input image 302 may also depict a user standing near the drawing board 304. The user may provide user-based content that is displayed on the drawing board 304. For example, the user may draw or write on a surface 306 of the drawing board 304 using a writing instrument, such as a colored marker, a pen, a stylus, a piece of chalk, or the like. The handwritten text, drawing, and/or graphical symbol represents user-based content. The user optionally may provide user-based content on the surface 306 in other ways, such as by selectively affixing a token on the surface 306. The token may be a magnet, a piece of note paper, a sticky note, a sticker, a decal, or the like. An example token 702 is shown in FIG. 7. The user can remove the user-based content that is displayed on the drawing board 304 by erasing handwritten text, drawings, and symbols and removing tokens from the surface 306.

The processor 102 analyzes the received image data and performs a drawing board detection function 308 to detect whether a drawing board 304 is present in the image data. For example, the processor 102 analyzes the input image 302 to detect the presence of the drawing board 304. In an embodiment, the processor 102 uses a board detection algorithm 112 to detect the drawing board 304 in the received image data. The board detection algorithm 112 may be stored in the memory 104.

FIG. 4 is an image 402 that depicts the drawing board 304 mounted on a wall 404 of a room 406. The image 402 may be an image that is generated by the camera 106 and analyzed by the processor 102 using the board detection algorithm 112. In an embodiment, the board detection feature may be active during a video conference meeting. For example, a setting may dictate that the processor 102 actively analyzes the image data generated by the camera 106 over time during a video conference meeting to detect the presence of the drawing board 304 in one or more image frames. Due to this automated function, the user does not need to navigate a menu in a graphical user interface and select one or more virtual buttons to turn on the board detection feature. In an alternative embodiment, the board detection feature may be inactive until the user provides a user input command via the I/O device 108 to activate the board detection feature.

In an example, the board detection algorithm 112 may be an object detector that is trained or designed to detect a drawing board in an image as a region of interest. The processor 102 may analyze the region of interest for edges 408 of the drawing board 304 based on pixel contours. The processor 102 may assemble the edges 408 into a frame 410 that represents an outer boundary of the drawing board 304. The frame 410 is rectangular in FIG. 4, and is skewed at an angle in the image. The frame 410 may have a different shape in other embodiments. The drawing board 304 may be described or identified by coordinate points at the four corners of the frame or outer boundary 410. The processor 102 may use the characteristics (e.g., corner coordinates, angles between edges 408, etc.) of the frame 410 for rectifying the image data that is received to form a virtual whiteboard image. The characteristics of the frame 410 may also be used by the processor 102 to delineate a search area in which to search for user-based content displayed on the surface 306 of the drawing board 304. For example, any text or other graphical symbols drawn by the user onto the surface 306 of the drawing board 304, as well as tokens applied on the surface 306, would be depicted in the portion of the image data that is within the surface area bounded by the frame 410. The board detection algorithm 112 may use an expected color of the drawing board 304 to assist with identifying the drawing board 304 in the image data and differentiating from other objects that may have similar shapes (e.g., other rectangular objects). For example, the board detection algorithm 112 may use a whiteboard color distribution, shape information of the whiteboard, and a size of the whiteboard to identify the area as a whiteboard (labeling the area as a whiteboard) to be able to distinguish it from other rectangular areas in the image (e.g., a painting). The algorithm 112 may be probabilistic, meaning that it may also work if the whiteboard is partially covered/obstructed and/or discolored (e.g., not clean).

Referring back to FIG. 3, once the processor 102 detects the drawing board 304 in the image data, the processor 102 performs a symbol detection function 310. The symbol detection function 310 includes the processor 102 analyzing a portion of the image data that is within the drawing board 304 (e.g., within the outer boundary or frame 410) to detect user-based content on the surface 306 of the drawing board 304. The user-based content is content that is selectively displayed on the surface 306 of the drawing board 304 by the user. In an embodiment, the processor 102 analyzes at least a majority of the surface area of the drawing board 304. For example, the processor 102 may analyze the image data corresponding to the entire surface area of the drawing board 304 (e.g., all of the image data within the outer boundary 410) in the search for user-based content. As described herein, some of the user-based content may be a code that commands the processor 102 to perform an activity, such as an editing function. As such, the user is not restricted in where the user decides to locate the command-signaling user-based content on the surface 306 of the drawing board 304. The user can position the user-based content at a location of the drawing board 304 that is convenient to the user, assuming that the user-based content is within the field of view of the camera 106 and the camera 106 has an unobstructed view of the user-based content. Alternatively, the user may be able to select, as a setting, that only a designated area along the surface 306 of the drawing board 304 is a region for placing user-based content signifying commands.

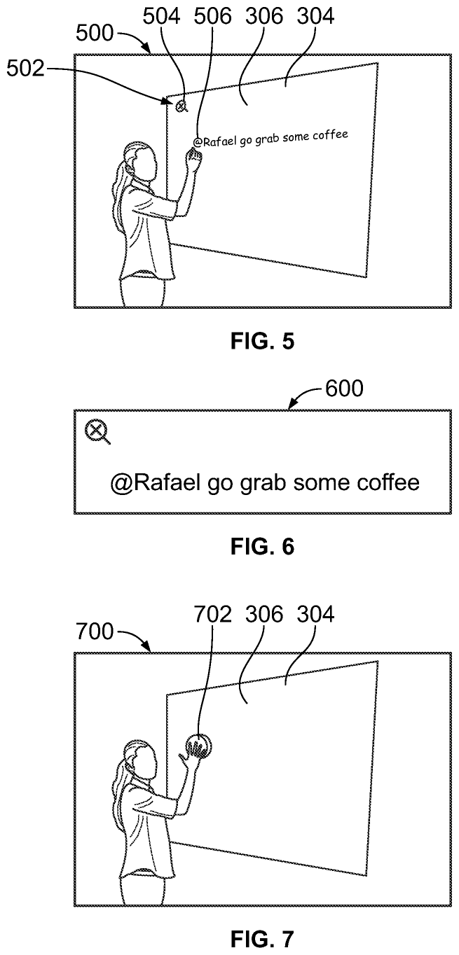

FIG. 5 is an image 500 showing a user presenting at the drawing board 304. The drawing board 304 may be a dry erase whiteboard. The user has applied user-based content 502 on the surface 306. In this case, the user-based content 502 includes graphical symbols that are handwritten or drawn by the user on the surface 306. For example, the user may use a marker or other writing instrument to draw the user-based content 502 on the surface 306.

In an embodiment, the virtual whiteboard system 100 defines associated relationships between some specific graphical symbols and commands. The relationships may be pre-defined as default settings. Optionally, the virtual whiteboard system 100 may enable a user to modify relationships and/or add new relationships for customization. The commands represent user-instructed operations to be performed by the processor 102. The operations may affect how content is displayed on a virtual whiteboard display interface to remote users that are not present in the room and that view the drawing board 304 via their remote computer device 204. For example, some commands may represent editing tasks to be performed on the content that is displayed on the virtual whiteboard display interface. By performing an editing task, the content that is shown on a virtual whiteboard image to a remote user may differ from the actual content that is displayed on the surface 306 of the drawing board 304. Example editing commands can include changing a zoom level of the virtual whiteboard display interface, highlighting text on the virtual whiteboard display interface, adding a mention to a remote user that can view the virtual whiteboard display interface, adding an emoji on the virtual whiteboard display interface, or displaying a designated file on the virtual whiteboard display interface. Each command can have at least one graphical symbol that is uniquely associated with that specific command based on the defined relationships.

The processor 102 may perform optical character recognition (OCR) on the portion of the image data within the drawing board 304 to detect the user-based content on the surface 306 of the drawing board 304. For example, the memory 104 may include an OCR algorithm 114 (shown in FIG. 1) that is utilized by the processor 102 to perform the OCR. The OCR algorithm 114 may be performed to recognize image data that represents known graphical symbols, such as letters, numbers, and other characters, and generate an accessible electronic version of the graphical symbols. The OCR algorithm 114 may be trained or designed to detect specific graphical symbols that are associated with commands as well as to detect letters, numbers, and other common characters.

In FIG. 5, a first graphical symbol 504 of the user-based content 502 is a letter “x” that is circled with a line segment extending from the circle. In a first case, the processor 102 may analyze the image data within the drawing board 304 using the OCR algorithm 114 to detect the presence of the first graphical symbol 504 on the surface 306. In a second case, the processor 102 may analyze the image data within the drawing board 304 using a pattern matching algorithm 115 to detect and recognize the first graphical symbol 504 on the surface 306. The processor 102 may determine a command associated with the first graphical symbol 504 that is detected.

In an embodiment, the memory 104 may store a command database 116 (shown in FIG. 1) that describes designated commands, designated graphical symbols, and the relationships between the designated commands and the designated graphical symbols. For example, the command database 116 may include a look-up table that provides a list of different types of user-based content (e.g., different graphical symbols) and corresponding commands that are associated with each of the different types. As an alternative, the designated graphical symbols and associated commands may be hardwired into the circuitry of the processor 102, rather than stored in the command database 116 in the memory 104.

In an example shown in FIGS. 5 and 6, the processor 102 determines that the first graphical symbol 504 is associated with a zoom-in command. The zoom-in command refers to an instruction for the processor 102 to perform a zoom-in function on at least a portion of the drawing board 304. The processor 102 implements the command to generate a virtual whiteboard image that has magnified content. By performing the zoom-in function, content that is displayed on a virtual whiteboard image to a remote user may be magnified relative to the size of the content before performing the zoom-in function.

FIG. 6 illustrates a virtual whiteboard image 600 that may be generated by the processor 102. The content shown in the virtual whiteboard image 600 is magnified by the processor 102 in response to determining that the user has signaled the zoom-in command by drawing the first graphical symbol 504 on the drawing board 304. Magnifying the content may help the remote users to view and interpret the content that the user presents on the drawing board 304.

The virtual whiteboard image 600 may be displayed on a virtual whiteboard display interface presented by a remote computer device 204. The virtual whiteboard display interface may be a graphical user interface that displays virtual whiteboard images generated by the processor 102 of the virtual whiteboard system 100. The virtual whiteboard images may collectively form a video feed that is output by the processor 102. During a video conference meeting, the virtual whiteboard display interface may be controlled by the video conferencing platform or program that is providing the video conference meeting. For example, the video conferencing platform or program may receive the video feed that is output from the virtual whiteboard system 100, and may render and/or rectify the video feed for presentation on its virtual whiteboard display interface. Optionally, the virtual whiteboard system 100 may include a virtual whiteboard display interface 124 stored in the memory 104. The virtual whiteboard images generated by the processor 102 may be output to remote user devices 204 as part of the virtual whiteboard display interface 124.

In an embodiment, the user can selectively stop or reverse commanded actions by changing the user-based content that is on the surface 306 of the drawing board 304. For example, after the processor 102 performs the zoom-in command, the user may eventually decide to change the magnification level of the content that is displayed on the virtual whiteboard display interface to the remote users. To return the magnification level to a previous or default zoom state, the user may simply erase the first graphical symbol 504 from the drawing board 304. The processor 102 analyzes second image data that is generated by the camera 106 after the content has been magnified and after the user has erased the first graphical symbol 504. The processor 102 detects that the first graphical symbol 504 is no longer displayed on the surface 306 of the drawing board 304. The processor 102 interprets this omission as a zoom-out command. The processor 102 implements a zoom-out function to generate a second virtual whiteboard image. The content displayed in the second virtual whiteboard image has a reduced magnification relative to the magnified content displayed in the earlier (first) virtual whiteboard image. As such, the virtual whiteboard system 100 may have a memory function, and may determine user commands based on removing user-based content from the surface 306 of the drawing board 304.

In the example shown in FIG. 5, the processor 102 also detects a second graphical symbol 506 on the surface 306 of the drawing board 304. The second graphical symbol 506 is an “at” symbol (@). The processor 102 may access the command database 116 and determine that the second graphical symbol 506 is associated with a mention command. The mention command may instruct the processor 102 to notify a specific remote user or group of remote users and optionally to set up a task or event for the notified user(s). As shown in FIGS. 5 and 6, the second graphical symbol 506 on the surface 306 is followed by text. The processor 102 may use the OCR algorithm 114 to recognize and interpret the text as reciting “Rafael go grab some coffee”. In an example, the processor 102 may determine that the user is submitting a mention command directed to the remote user named Rafael as the recipient. The processor 102 then implements the mention command. The processor 102 may implement the mention command by communicating a notification to the user Rafael that attempts to focus the attention of Rafael on the text to “go grab some coffee.” For example, the processor 102 may generate a virtual whiteboard image for Rafael's computer device which augments the text “Rafael go grab some coffee” to draw Rafael's attention to the message. The augmentation in the virtual whiteboard image may be to highlight the text, flash the text, control an audio device of Rafael's computer device 204 to emit a sound, control a haptic device of Rafael's computer device 204 to vibrate, or the like. Optionally, the processor 102 may generate a task that is communicated to Rafael's computer device 204. The task may be communicated to a calendar program, a task program, or the like. The task may include the description “grab some coffee”, and optionally may identify the user at the drawing board 304 as the source of the task.

In an embodiment, the processor 102 is also designed to detect physical objects affixed to the surface 306 of the drawing board 304 and interpret the objects as user commands. Such objects are referred to as tokens herein. FIG. 7 is an image 700 showing the user presenting at the drawing board 304. The user in the image 700 is affixing a token 702 to the surface 306. The token 702 is an example type of user-based content that is displayed on the surface 306. The token 702 may be a magnet, a sticker, a sticky note, a piece of note paper, or the like. The token 702 may be selectively affixed to the surface 306 via magnetic attractive forces, adhesion, or the like. The token 702 has one or more characteristics that can be detected by the processor 102 in the image data and used to identify the token 702. For example, the color, shape, design, and/or size of the token 702 may be used by the processor 102 to identify the token 702. Once the token 702 is identified, the processor 102 determines the command associated with the token 702 and implements the command.

For example, the token 702 may be associated with displaying a designated file on the virtual whiteboard display interface. The designated file may be a video, image, slide of a presentation, or the like. The user may select the file and establish the relationship between the file and the token 702 prior to presenting. During the presentation, the user may affix the token 702 to the drawing board 304 at a time that the user desires the remote participants to view the pre-selected file. Upon detecting and identifying the token 702, the processor 102 may access the command database 116 to determine the commanded action. The processor 102 may then obtain the file, such as from the memory 104, and generate a virtual whiteboard image or series of images that present the file. As such, the remote participants viewing the virtual whiteboard display interface are able to view the contents of the file during the user's presentation. The user can queue multiple files to be shown during a presentation by affixing different designated tokens to the drawing board 304. The processor 102 may remove the file from the virtual whiteboard display interface automatically in response to the file reaching an end state or after a designated amount of time. Alternatively, the processor 102 may remove the file from the virtual whiteboard display interface in response to detecting that the user has removed the token 702 from the drawing board 304.

Referring back to FIG. 3, once the processor 102 detects the drawing board 304 in the image data, the processor 102 in an embodiment performs a sharpening function 312. The sharpening function 312 may be performed after the symbol detection function 310, before the symbol detection function 310, or concurrently with the symbol detection function 310. The sharpening function 312 is designed to clarify and enhance handwritten content using OCR-based text recognition and inpainting techniques. For example, the inpainting techniques may be rendering techniques that augment the original character content handwritten by the user to enhance the characters and make the characters more legible, standardized in shape, and/or have a greater contrast with the surrounding area of the board 304.

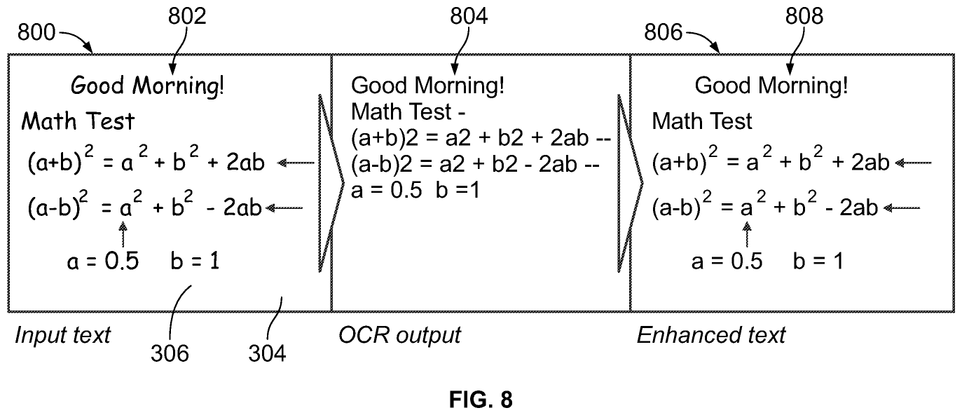

FIG. 8 is a diagram that shows an input image 800, an OCR output 804, and a virtual whiteboard image 806 to explain the sharpening function 312 according to an embodiment. The input image 800 may be generated by the camera 106. The input image 800 depicts a sample of handwritten text 802 on the surface 306 of the drawing board 304. The processor 102 may perform text recognition on the portion of the image data that depicts the handwritten text 802 using the OCR algorithm 114. The output of the OCR algorithm 114 may be the OCR output 804. The processor 102 may then apply the inpainting techniques to the image data depicting the handwritten text 802, based on the OCR output 804, to generate the virtual whiteboard image 806. The virtual whiteboard image 806 includes a set of enhanced handwritten text 808. The enhanced handwritten text 808 may resemble the original handwritten text 802, although may have adjustments to increase the legibility of the text. For example, the enhanced handwritten text 808 may have a greater contract ratio, may have more consistent line weights, may have generally thicker line weights, and/or the like, than the original handwritten text 802.

In an embodiment, the processor 102 may implement the sharpening function 312 by identifying a first character drawn by the user on the surface 306 of the drawing board 304. The first character may be identified after the user finished a word or sentence that includes the first character. The processor 102 may identify the first character by applying the OCR algorithm 114, a pattern-matching algorithm 115, or the like. The processor 102 may then select a first set of sharpening parameters based on the identity of the first character. The sharpening parameters may be stored in a sharpening parameter database 118 (shown in FIG. 1) of the memory 104. For example, each character in a list may have its own corresponding set of sharpening parameters. Optionally, every letter in the alphabet has a different set of sharpening parameters. If the first character is identified as a “d”, the processor 102 may access the sharpening parameter database 118 to obtain the set corresponding to the letter “d”. Optionally, upper case letters may have different parameter sets than lower case letters of the same character. Furthermore, different parameter sets may be applied to the same character written in script form versus written in block letter form.

After selecting the appropriate first set of sharpening parameters based on the identity of the first character, the processor 102 may apply a sharpening filter 120 (shown in FIG. 1) that has the first set of sharpening parameters to the portion of the image data that depicts the first character. The sharpening filter 120 may be stored in the memory 104. In an example, the sharpening filter 120 is a form of high pass filter. The processor 102 may render an output of the sharpening filter 120 to present an enhanced first character as part of the enhanced handwritten text 808 on the virtual whiteboard image 806. The sharpening function 312 may be applied during rendering as part of the graphics output during shading to determine the final color per pixel.

In an example, the processor 102 may perform an optimization task in the selection and application of the sharpening parameters. For example, after generating the enhanced first character, the processor 102 may compare the enhanced first character to a character predesignated as a target character. The difference between the enhanced first character and the target character may be described as an output means square error (MSE) loss for the first character. The processor 102 may then modify the parameter set in the sharpening filter 120 to generate an updated enhanced first character in an attempt to reduce the MSE loss between the updated enhanced first character and the target character. This process may be repeated by the processor 102 multiple times, using different sharpening parameter sets in the sharpening filter 120 until an end point is reached. The end point may be reached when no further loss reduction is noticeable, a time limit has occurred, and/or a number of the adjustments has reached a limit (e.g., to prevent a deadlock). The approach may be used to train the sharpening filter 120 and/or the processor 102 to determine which parameters sets to apply to different characters in the future. For example, once the filter parameters are selected for the first character, the processor 102 may automatically use those filter parameters when detecting additional instances of the first character in the handwritten text 802. Optionally, a sequence alignment algorithm (e.g., Neddleman-Wunsch Score) may be applied on the OCR-recognized text 804 by the processor 102 to identify text similarities. The sequence alignment algorithm may determine (i) if text is new, (ii) has been updated, or (iii) has already been processed.

With reference to FIG. 3, the processor 102 may perform a tracking function 314 to track the drawing board 304 for updating the drawing board boundary as input for the board detection algorithm 112. The drawing board boundary may need to be updated when the user slightly moves the laptop while the drawing board (e.g., whiteboard) is within the field of view of the camera 106 and for supporting functions reducing camera vibrations and other movements that could degrade image quality (e.g., clarity and/or resolution). Image motion can be due to (i) the user intentionally moving the laptop and changing the camera alignment and/or (ii) unintentional motion caused by a table on which the laptop is located shaking or other vibrations. Some laptops have cameras located in the top cover display panel, and the hinges that hold the top cover display panel may not rigidly secure the top cover display panel, permitting some slight movement of the camera.

The virtual whiteboard system 100 may be designed to remedy intentional movement of the camera 106 by applying a first algorithm to the image data that depicts the drawing board 304 to detect edges 408 of the drawing board 304 and determine the outer boundary 410 of the drawing board 304. The first algorithm may be the board detection algorithm 112 that is used to identify the drawing board 304 within the image data as a region-of-interest and to use edge detection to generate the frame or outer boundary 410 of the drawing board 304.

To remedy the unintentional shaking of the camera 106, the virtual whiteboard system 100 may use the outer boundary 410 of the drawing board 304 with a motion stability filter 122 (shown in FIG. 1). For example, the processor 102 may use multiple points along the outer boundary 410 of the drawing board 304 to determine (e.g., approximate) a plane. The plane may then be used by the processor 102 to determine a plane normal vector for the drawing board 304. The processor 102 may then apply the motion stability (e.g., motion stabilizing) filter 122 based on the plane normal vector to correct for motion of the camera by removing high frequency components from the normal vector. The result is that the filter 122 may reduce high-frequency motion in the image data within the outer boundary 410 of the drawing board 304. Such high-frequency motion that is reduced may be induced by unintentional shaking of the camera 106. The motion stability filter 122 may be stored in the memory 104. The motion stability filter 122 may be a motion stabilizing Kalman filter to reduce high frequency (HF) motion in every frame. In an example, the filter 122 may be a bayes filter, which is a type of Kalman filter. The processor 102 may apply the motion stability filter 122 to the portion of the image data within the outer boundary 410 of the drawing board 304.

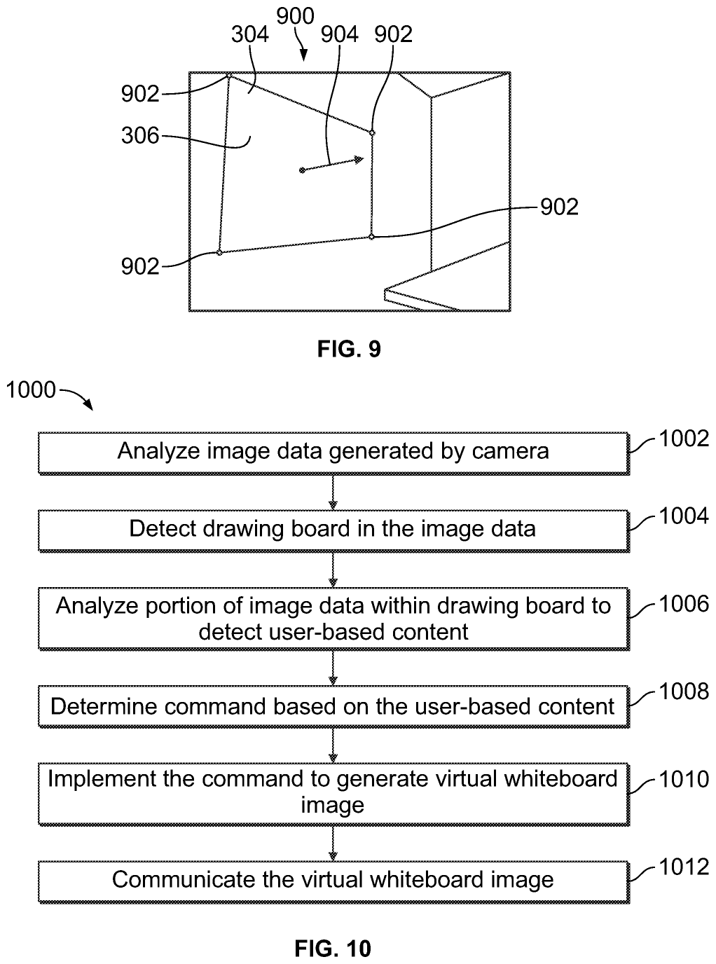

FIG. 9 is an image 900 depicting the drawing board 304 in a room according to an embodiment. In an embodiment, the processor 102 may use the coordinates of at least some of the corner points 902 of the drawing board 304 in the image data to determine (e.g., approximate) a plane of the surface 306. The processor 102 may then determine the plane normal vector 904 based on the plane. The motion stability filter 122 may be applied, based on the plane normal vector 904, to stabilize the plane normal vector 904 to prohibit motion, yielding an enhanced plane. The processor 102 may use the enhanced plane to correct the measured points and use them to zoom into the drawing board 304.

Referring back to FIG. 3, the virtual whiteboard system 100 may generate a virtual whiteboard image 316 after performing the various functions 308, 310, 312, 314 on the received image data. The virtual whiteboard image 316 may be a modified version of the input image 302. For example, the virtual whiteboard image 316 may have edits and/or augmentations based on user commands provided by the user selectively displaying graphical symbols on the surface 306 of the drawing board 304. In another example, handwritten text shown in the virtual whiteboard image 316 may be enhanced via the sharpening function 312 to be more legible to remote observers that receive the virtual whiteboard image 316. The content on the virtual whiteboard image 316 may have improved clarity and resolution due to the motion tracking and stabilizing function 314. The virtual whiteboard image 316 may be communicated to one or more remote computer devices 204 to allow one or more remote participants of a video conference meeting to view the virtual whiteboard image.

In an embodiment, the processor 102 may record text representing the user-based content on the drawing board that is detected via the OCR algorithm 114 over time. The text that is recorded may be presented by a user during a video conference meeting. The processor 102 may store the OCR output text in the memory 104 or another storage device. The processor 102 may generate an exportable document that includes a transcript of the text that is recorded during the video conference meeting. The exportable document may be a PDF or another electronically formatted document. Optionally, the processor 102 may generate the transcript to include handwritten drawings and other graphic symbols presented by the user on the drawing board 304, besides text. The processor 102 may export the transcript on demand to a computer device.

FIG. 10 is a flow chart 1000 of a method of enhancing a virtual whiteboard according to an embodiment. The method may be performed entirely or in part by the one or more processors 102 of the virtual whiteboard system 100. The method optionally may include at least one additional step than shown, at least one fewer step than shown, and/or at least one different step than shown.

At step 1002, image data generated by a camera 106 is analyzed. At step 1004, a drawing board 304 in the image data is detected. At step 1006, a portion of the image data that is within the drawing board 304 is analyzed to detect user-based content 502 that is selectively displayed on a surface 306 of the drawing board 304 by a user. In an example, analyzing the portion of the image data is performed to detect at least one of (i) content that is handwritten by the user on the surface 306 of the drawing board 304 using a writing instrument or (ii) a token 702 that is manually affixed to the surface 306 of the drawing board 304 by the user. The user-based content may be detected by performing optical character recognition or pattern matching on the portion of the image data within the drawing board 304.

At step 1008, a command is determined that is associated with the user-based content 502 that is on the surface 306 of the drawing board 304. At step 1010, the command is implemented to generate a virtual whiteboard image 316. For example, the command may be implemented by editing content and/or augmenting content displayed on a virtual whiteboard display interface 124.

At step 1012, the virtual whiteboard image 316 is communicated to one or more remote computer devices 204 to allow one or more remote participants of a video conference meeting to view the virtual whiteboard image 316.

In an embodiment, the method also includes text sharpening. The text sharpening may include identifying a first character drawn by the user on the surface 306 of the drawing board 304 based on optical character recognition, and selecting a first set of sharpening parameters based on an identity of the first character. The text sharpening may include applying a form of sharpening high pass filter having the first set of sharpening parameters to a portion of the image data that depicts the first character, and rendering an output of the sharpening high pass filter to present the first character on the virtual whiteboard image 316.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), complex instruction set computer (CISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B” represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A virtual whiteboard system comprising:
a memory configured to store program instructions; and
one or more processors operably connected to the memory, wherein the program instructions are executable by the one or more processors to:
analyze image data generated by a camera;
detect a drawing board in the image data;
analyze a portion of the image data that is within the drawing board to detect user-based content that is selectively displayed on a surface of the drawing board by a user;
determine a command associated with the user-based content that is on the surface of the drawing board; and
implement the command to generate a virtual whiteboard image.

2. The virtual whiteboard system of claim 1, wherein the one or more processors are configured to communicate the virtual whiteboard image to one or more remote computer devices to allow one or more remote participants of a video conference meeting to view the virtual whiteboard image.

3. The virtual whiteboard system of claim 1, wherein the one or more processors are configured to analyze the portion of the image data within the drawing board to detect at least one of (i) a token that is manually affixed to the surface of the drawing board by the user or (ii) content that is handwritten by the user on the surface of the drawing board using a writing instrument.

4. The virtual whiteboard system of claim 1, wherein the one or more processors are configured to analyze the portion of the image data within the drawing board to detect a graphical symbol that represents the user-based content.

5. The virtual whiteboard system of claim 1, wherein the one or more processors are configured to analyze the portion of the image data within the drawing board to detect the user-based content by performing optical character recognition on the portion of the image data within the drawing board.

6. The virtual whiteboard system of claim 5, wherein the one or more processors are configured to:
identify a first character drawn by the user on the surface of the drawing board based on the optical character recognition;
select a first set of sharpening parameters based on an identity of the first character;
apply a sharpening high pass filter having the first set of sharpening parameters to a portion of the image data that depicts the first character; and
render an output of the sharpening high pass filter to present the first character on the virtual whiteboard image.

7. The virtual whiteboard system of claim 5, wherein the one or more processors are configured to:
record text representing the user-based content on the drawing board that is detected via the optical character recognition over time; and
generate an exportable document that includes a transcript of the text that is recorded during a video conference meeting.

8. The virtual whiteboard system of claim 1, wherein the one or more processors are configured to analyze the portion of the image data within the drawing board to detect the user-based content by performing optical pattern matching on the portion of the image data within the drawing board.

9. The virtual whiteboard system of claim 1, wherein the one or more processors are configured to determine the command associated with the user-based content by accessing a look-up table that provides a list of different types of user-based content and corresponding commands associated with the different types.

10. The virtual whiteboard system of claim 1, wherein, in response to determining that the command is to perform a zoom-in function, the one or more processors are configured to implement the command by magnifying content that is displayed in the virtual whiteboard image.

11. The virtual whiteboard system of claim 10, wherein the one or more processors are configured to:
analyze second image data generated by the camera after the content displayed on the virtual whiteboard image is magnified; and
in response to detecting that the user-based content associated with the zoom-in function is no longer displayed on the surface of the drawing board, implementing a zoom-out function to generate a second virtual whiteboard image.

12. The virtual whiteboard system of claim 1, wherein the one or more processors are configured to implement the command by one or more of changing a zoom level of a virtual whiteboard display interface, highlighting text on the virtual whiteboard display interface, adding a mention to a remote user that can view the virtual whiteboard display interface, adding an emoji on the virtual whiteboard display interface, or displaying a designated file on the virtual whiteboard display interface.

13. The virtual whiteboard system of claim 1, wherein the one or more processors are configured to analyze the portion of the image data that is within the drawing board to detect the user-based content by analyzing all of the image data that is within an outer boundary of the drawing board.

14. The virtual whiteboard system of claim 1, wherein the one or more processors are configured to:
apply a first algorithm to the image data that depicts the drawing board to detect edges of the drawing board;
determine a plane normal vector of the drawing board; and
apply a motion stability filter based on the plane normal vector to correct for motion of the camera by removing high frequency components from the image data within the outer boundary of the drawing board.

15. A method of enhancing a virtual whiteboard, the method comprising:
analyzing image data generated by a camera;
detecting a drawing board in the image data;
analyzing a portion of the image data that is within the drawing board to detect user-based content that is selectively displayed on a surface of the drawing board by a user;
determining a command associated with the user-based content that is on the surface of the drawing board; and
implementing the command to generate a virtual whiteboard image.

16. The method of claim 15, further comprising communicating the virtual whiteboard image to one or more remote computer devices to allow one or more remote participants of a video conference meeting to view the virtual whiteboard image.

17. The method of claim 15, wherein analyzing the portion of the image data within the drawing board is performed to detect at least one of (i) content that is handwritten by the user on the surface of the drawing board using a writing instrument or (ii) a token that is manually affixed to the surface of the drawing board by the user.

18. The method of claim 15, wherein implementing the command to generate the virtual whiteboard image comprises one or more of editing content or augmenting content displayed on a virtual whiteboard display interface.

19. The method of claim 15, further comprising:
performing optical character recognition on the portion of the image data within the drawing board to detect the user-based content;
identifying a first character drawn by the user on the surface of the drawing board based on the optical character recognition;
selecting a first set of sharpening parameters based on an identity of the first character;
applying a sharpening high pass filter having the first set of sharpening parameters to a portion of the image data that depicts the first character; and
rendering an output of the sharpening high pass filter to present the first character on the virtual whiteboard image.

20. A computer program product comprising a non-transitory computer readable storage medium, the non-transitory computer readable storage medium comprising computer executable code configured to be executed by one or more processors to:
analyze image data generated by a camera;
detect a drawing board in the image data;
analyze a portion of the image data that is within the drawing board to detect user-based content that is selectively displayed on a surface of the drawing board by a user;
determine a command associated with the user-based content that is on the surface of the drawing board; and
implement the command to generate a virtual whiteboard image.
